(19) United States
(12) Patent Application Publication
(10) Pub. No.: US 2008/0177025 A1
(43) Pub. Date: Jul. 24, 2008

(54) Double metal cyanide catalysts for the preparation of polyether polyols

(76) Inventor: Jorg Hofmann, Krefeld (DE)

Correspondence Address: BAYER MATERIAL SCIENCE LLC, 100 BAYER ROAD, PITTSBURGH, PA, 15205, US

(21) Appl. No.: 12/008,940

(22) Filed: Jan. 15, 2008

(30) Foreign Application Priority Data
Jan. 17, 2007 (DE) 102007002555.8

(51) Int. Cl. C08G 65/04; B01J 31/22

(52) U.S. Cl. 528/412; 502/156; 528/414

(57) ABSTRACT

The present invention relates to double metal cyanide DMC catalysts containing one or more double metal cyanide compounds of the formula M[M′(CN)₄] and one or more organic complexing ligands. The inventive catalysts, when used for the preparation of polyether polyols by polyaddition of alkylene oxides on to starter compounds containing active hydrogen atoms, have little or no induction period and produce polyols with very low double bond contents.

### FIELD OF THE INVENTION

The invention relates to novel double metal cyanide (DMC) catalysts for the preparation of polyether polyols by polyaddition of alkylene oxides on to starter compounds containing active hydrogen atoms.

### BACKGROUND OF THE INVENTION

Double metal cyanide (DMC) catalysts for the polyaddition of alkylene oxides on to starter compounds containing active hydrogen atoms are known (see e.g. U.S. Pat. No. 3,404,109; U.S. Pat. No. 3,829,505; U.S. Pat. No. 3,941,849; and U.S. Pat. No. 5,158,922). The use of these DMC catalysts for the preparation of polyether polyols has the effect, in particular, of a reduction in the content of monofunctional polyethers with terminal double bonds, so-called monools, compared with the conventional preparation of polyether polyols by means of alkali catalysts, such as alkali metal hydroxides. The polyether polyols obtained in this way can be processed to high-quality polyurethanes (e.g. elastomers, foams, coatings). DMC catalysts are usually obtained by reacting an aqueous solution of a metal salt with an aqueous solution of a metal cyanide salt in the presence of an organic complexing ligand, e.g. an ether. In a typical preparation of the catalysts, for example, aqueous solutions of zinc chloride (in excess) and potassium hexacyanocobaltate are mixed, and dimethoxyethane (glyme) is then added to the suspension formed. After filtration and washing of the catalyst with aqueous glyme solution, an active catalyst of the general formula

Zn₃[Co(CN)₆]₂.xZnCl₂.yH₂O.z glyme

is obtained (See e.g. EP-A 700 949).

JP-A 4 145 123, U.S. Pat. No. 5,470,813, EP-A 700 949, EP-A 743 093, EP-A 761 708 and WO 97/40086 disclose DMC catalysts which, by the use of tert-butanol as an organic complexing ligand (by itself or in combination with a polyether (EP-A 700 949, EP-A 761 708, WO 97/40086)), further reduce the content of monofunctional polyethers with terminal double bonds in the preparation of polyether polyols. Nevertheless, the double bond content of the polyether polyols which are obtained by means of these improved DMC catalysts continues to lie at values of at least 3 mmol/kg (see e.g. EP-A 700 949, EP-A 761 708, WO 97/40086). By the use of these DMC catalysts, the induction time in the polyaddition reaction of the alkylene oxides with corresponding starter compounds is moreover reduced and the catalyst activity is increased. Nevertheless, an induction period still also arises with these DMC catalysts. This induction period is undesirable in principle from the production aspect, because it leads to a reduction in the space/time yield. The induction period also leads to a severe release of heat and therefore an uncontrolled increase in temperature can occur during activation of the catalyst, which may cause an increased exposure of the polyether polyol to heat and an impairment in the product quality. There is also the danger that the catalyst activity is impaired by accelerated thermal ageing.

Robertson et al. in Dalton Trans., 2006, 5390-5395 describe the homo- and copolymerization of propylene oxide by catalysis with cobalt tetracyanonickelate (Co[Ni(CN)₄]). Nevertheless, the above-mentioned undesirable induction period also occurs when the DMC catalyst of Robertson et al. is used, and the double bond content of the polyether polyol obtained therewith continues to be high.

### SUMMARY OF THE INVENTION

It has now been found that DMC catalysts which, in addition to a DMC compound of the formula M[M′(CN)₄], contain one or more organic complexing ligands no longer have an induction period in the preparation of polyether polyols, and that the polyether polyols obtained by using these DMC catalysts have extremely low double bond contents.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

The present invention therefore provides double metal cyanide (DMC) catalysts containing
a) one or more, preferably one, double metal cyanide compound of the formula

M[M′(CN)₄],
wherein
M is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II), and
M′ is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II),
b) one or more organic complexing ligands chosen from the group consisting of alcohols, aldehydes, ketones, ethers, esters, amides, ureas, nitriles and sulfides,
   and optionally
c) one or more complexing component(s) which differ from b) from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, or of glycidyl ethers, glycosides, carboxylic acid esters of polyhydric alcohols, bile acids or salts, esters or amides thereof, cyclodextrins, phosphorus compounds, α,β-unsaturated carboxylic acid esters and ionic surface- or interface-active compounds.

The catalysts according to the invention can optionally contain d) water, preferably 1 to 10 wt. %, and/or e) one or more water-soluble metal salts, preferably 5 to 25 wt. %, of the formula (I) M(X)ₙ from the preparation of the double metal cyanide compounds a). In formula (I), M is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II). Zn(II), Fe(II), Co(II) and Ni(II) are particularly preferred. X are identical or different, preferably identical anions, preferably chosen from the group consisting of halides, hydroxides, sulfates, carbonates, cyanates, thiocyanates, isocyanates, isothiocyanates, carboxylates, oxalates or nitrates. The value for n is 1 or 2.

The double metal cyanide compounds a) present in the catalysts according to the invention may be obtained by reaction of water-soluble metal salts and water-soluble metal cyanide salts. Instead of the water-soluble metal cyanide salts, it is also possible to employ the corresponding acids, which may be obtained, for example, from the metal salts by ion exchange.

Water-soluble metal salts which are suitable for the preparation of double metal cyanide compounds a) preferably have the formula:

M(X)ₙ (I)

wherein M is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II). Zn(II), Fe(II), Co(II) and Ni(II) are particularly preferred. The anions X are identical or different, preferably identical, and are preferably chosen from the group consisting of halides, hydroxides, sulfates, carbonates, cyanates, thiocyanates, isocyanates, isothiocyanates, carboxylates, oxalates or nitrates. The value for n is 1 or 2.

Examples of suitable water-soluble metal salts are zinc(II) chloride, zinc(II) bromide, zinc(II) acetate, zinc(II) acetylacetonate, zinc(II) benzoate, zinc(II) nitrate, iron(II) sulfate, iron(II) bromide, iron(II) chloride, cobalt(II) chloride, cobalt(II) sulfate, cobalt(II) thiocyanate, cobalt(II) nitrate, nickel(II) chloride, nickel(II) sulfate and nickel(II) nitrate. Mixtures of various water-soluble metal salts can also be employed.

Water-soluble metal cyanide salts which are suitable for the preparation of double metal cyanide compounds a) preferably have the formula:

(Y)ₐM′(CN)₄ (II)

wherein M′ is chosen from the metals Zn(II), Fe(II), Ni(II), Mn(II), Co(II), Sn(II), Pb(II), Sr(II), Cu(II), Cd(II), Hg(II), Pd(III), Pt(II), V(II), Mg(II), Ca(II) and Ba(II). M′ is particular preferably chosen from the metals Co(II), Fe(II), Ni(II), Zn(II), Pd(II) and Pt(II). The water-soluble metal cyanide salt can contain one or more of these metals. The cations Y are identical or different, preferably identical, and are chosen from the group comprising the alkali metal ions and alkaline earth metal ions. The value for a is 1 or 2. Examples of suitable water-soluble metal cyanide salts are potassium tetracyanonickelate(II), potassium tetracyanopalladate(II) and potassium tetracyanoplatinate(II).

Examples of suitable double metal cyanide compounds a) of the formula M[M′(CN)₄] contained in the catalysts according to the invention are zinc(II) tetracyanonickelate(II), cobalt(II) tetracyanonickelate(II), cobalt(II) tetracyanopalladate(II) and cobalt(II) tetracyanoplatinate(II). Cobalt(II) tetracyanonickelate(II) is particularly preferably used.

The organic complexing ligands b) contained in the DMC catalysts according to the invention are known and described in detail in the art (for example in U.S. Pat. No. 5,158,922; U.S. Pat. No. 3,404,109; U.S. Pat. No. 3,829,505; U.S. Pat. No. 3,941,849; EP-A 700 949; EP-A 761 708; JP-A 4 145 123; U.S. Pat. No. 5,470,813; EP-A 743 093; WO 97/40086; WO 00/02951; and EP-A 1 529 566). Preferred organic complexing ligands are water-soluble organic compounds with hetero atoms, such as oxygen, nitrogen, phosphorus or sulfur, which can form complexes with the double metal cyanide compound a). Suitable organic complexing ligands are e.g. alcohols, aldehydes, ketones, ethers, esters, amides, ureas, nitriles, sulfides and mixtures thereof. Preferred organic complexing ligands are aliphatic ethers, such as dimethoxyethane, and water-soluble aliphatic alcohols, such as ethanol, isopropanol, n-butanol, iso-butanol, sec-butanol, tert-butanol, 2-methyl-3-buten-2-ol and 2-methyl-3-butyn-2-ol. Organic complexing ligands which contain both aliphatic ether groups and aliphatic hydroxyl groups are also preferred, e.g. ethylene glycol mono-tert-butyl ether, diethylene glycol mono-tert-butyl ether and tripropylene glycol mono-methyl ether. Dimethoxyethane, tert-butanol, 2-methyl-3-buten-2-ol, 2-methyl-3-butyn-2-ol and ethylene glycol mono-tert-butyl ether are particularly preferred.

The organic complexing ligand b) may be added either during the preparation of the catalyst or immediately after the precipitation of the double metal cyanide compound a). The organic complexing ligand is preferably employed in excess.

The DMC catalysts according to the invention contain the double metal cyanide compounds a) in amounts of from preferably 20 to 90 wt. %, more preferably 25 to 80 wt. %, based on the amount of the finished catalyst, and the organic complexing ligands b) in amounts of from preferably 0.5 to 30 wt. %, more preferably 1 to 25 wt. %, based on the amount of the finished catalyst. The DMC catalysts according to the invention optionally additionally contain preferably 1 to 80 wt. %, more preferably 1 to 40 wt. %, based on the amount of the finished catalyst, of one or more complexing component(s) which differ from b) from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, glycidyl ethers, glycosides, carboxylic acid esters of polyhydric alcohols, bile acids or salts, esters or amides thereof, cyclodextrins, phosphorus compounds, α,β-unsaturated carboxylic acid esters and ionic surface- or interface-active compounds. Preferred catalysts contain as component c) polyethers, in particular polyether polyols.

The catalysts according to the invention may be crystalline, partly crystalline or amorphous. The crystallinity is analyzed by powder x-ray diffractometry.

Particularly preferred catalysts according to the invention contain
a) cobalt(II) tetracyanonickelate(II),
b) tert-butanol,
   and optionally
c) one or more complexing component(s) of the abovementioned type, in particular polyether polyols, very particularly those having a number-average molecular weight of from 500 to 4,000 g/mol.

The DMC catalysts according to the invention are preferably prepared in aqueous solution by reaction of metal salts, in particular of the formula (I), with metal cyanide salts, in particular of the formula (II), in the presence of organic complexing ligands b), and optionally further complexing components c).

Preferably, in this context, the aqueous solutions of the metal salt (e.g. cobalt(II) sulfate, employed in a stoichiometric excess of at least 50 mol %, based on the metal cyanide salt) and of the metal cyanide salt (e.g. potassium tetracyanonickelate) are first reacted in the presence of the organic complexing ligand b) (e.g. tert-butanol), a suspension which contains the double metal cyanide compound a) (e.g. cobalt(II) tetracyanonickelate(II), water d), excess metal salt e) and the organic complexing ligand b) being formed.

In this context, the organic complexing ligand b) may be present in the aqueous solution of the metal salt and/or of the metal cyanide salt, or it may be added immediately to the suspension obtained after precipitation of the double metal cyanide compound a). The variant in which the organic complexing ligand b) is already present in the aqueous solution of the metal salt and/or of the metal cyanide salt is preferred. It has proved advantageous to mix the aqueous solutions and the organic complexing ligand b) with vigorous stirring. The suspension formed is then optionally treated with one or more complexing components c).

The complexing components c) are preferably employed in this context in a mixture with water and organic complexing ligand b).

The catalyst is then isolated from the suspension by known techniques, such as centrifugation or filtration. In a preferred embodiment, the catalyst isolated is then washed with an aqueous solution of the organic complexing ligand b) (e.g. by re-suspension and subsequent renewed isolation by filtration or centrifugation, or by a process of washing of the filter cake, such as is described in WO 01/80994). Residual amounts of water-soluble by-products can be removed from the catalyst according to the invention in this manner.

The amount of organic complexing ligand b) in the aqueous wash solution is preferably 40 to 80 wt. %, based on the total solution. A small amount of the complexing component c) is optionally added to the aqueous wash solution, preferably 0.5 to 5 wt. %, based on the total solution.

It is moreover advantageous to wash the catalyst more than once. For this e.g. the first washing operation can be repeated. However, it is preferable to use non-aqueous solutions, e.g. of organic complexing ligands b) or a mixture of organic complexing ligands b) and complexing components c), for further washing operations.

The washed catalyst is then dried, optionally after pulverization, at temperatures of from preferably 20 to 100° C. under pressures of from preferably 0.1 mbar to normal pressure (1,013 mbar).

The present invention also provides for the use of the DMC catalysts according to the invention in processes for the preparation of polyether polyols by polyaddition of alkylene oxides on to starter compounds containing active hydrogen atoms.

Alkylene oxides which are employed are, preferably, ethylene oxide, propylene oxide, butylene oxide and mixtures thereof. The building up of the polyether chains by alkoxylation can be carried out e.g. with only one monomeric epoxide, or can also take place randomly or blockwise with 2 or 3 different monomeric epoxides. Further details are to be found in “Ullmanns Encyclopädie der industriellen Chemie”, volume A21, 1992, p. 670 et seq. In addition, monomers which can be copolymerized with the alkylene oxides in the presence of the catalysts according to the invention can also be employed. Examples of such comonomers are oxetanes, anhydrides, lactones, lactide or carbon dioxide.

Starter compounds containing active hydrogen atoms which are preferably employed are compounds having (number-average) molecular weights of from 18 to 2,000 and 1 to 8 hydroxyl groups. Examples are ethylene glycol, diethylene glycol, triethylene glycol, 1,2-propylene glycol, dipropylene glycol, 1,4-butanediol, hexamethylene glycol, bisphenol A, bisphenol F, trimethylolpropane, glycerol, castor oil, pentaerythritol, sorbitol, cane sugar, degraded starch or water.

Those starter compounds containing active hydrogen atoms which have been prepared e.g. by conventional alkali catalysis from the abovementioned low molecular weight starters and are oligomeric alkoxylation products having (number-average) molecular weights of from 200 to 2,000 are also advantageously employed.

The polyaddition of alkylene oxides on to starter compounds containing active hydrogen atoms which is catalyzed by the catalysts according to the invention is in general carried out at temperatures of from 20 to 200° C., preferably in the range of from 40 to 180° C., particularly preferably at temperatures of from 50 to 150° C. The reaction can be carried out under total pressures of from 0.0001 to 20 bar. The polyaddition can be carried out in bulk or in an inert organic solvent, such as toluene and/or THF. The amount of solvent is conventionally 10 to 30 wt. %, based on the amount of polyether polyol to be prepared.

The catalyst concentration is chosen such that good control of the polyaddition reaction is possible under the given reaction conditions. The catalyst concentration is preferably 0.0005 wt. % to 1 wt. %, more preferably 0.001 wt. % to 0.2 wt. %, based on the amount of polyether polyol to be prepared.

The (number-average) molecular weights of the polyether polyols prepared by the process according to the invention are preferably 500 to 100,000 g/mol, more preferably 1,000 to 50,000 g/mol, and most preferably 2,000 to 20,000 g/mol.

The polyaddition can be carried out continuously or discontinuously, e.g. in a batch process or in the semi-batch process.

The DMC catalysts according to the invention have no induction period in the preparation of polyether polyols, in contrast to the DMC catalysts found in the art. Furthermore, polyether polyols which have extremely low double bond contents are obtained by using these DMC catalysts. Preferred polyether polyols according to the invention have double bond contents of not more than 2 mmol/kg, particularly preferably less than 1 mmol/kg, even at molar masses of 1,000 g/mol and more, preferably also at molar masses of at least 2,000 g/mol. Polyether polyols having such low double bond contents were not known hitherto.

### EXAMPLES

The present invention is further illustrated, but is not to be limited, by the following examples. All quantities given in “parts” and “percents” are understood to be by weight, unless otherwise indicated.

### Catalyst Preparation

### Example A

### DMC Catalyst Containing Co[Ni(CN)₄] and Tert-Butanol

A solution of 11.1 g (48.8 mmol) cobalt(II) sulfate heptahydrate in 15 ml distilled water was added to a solution of 2.9 g (12 mmol) potassium tetracyanonickelate in 75 ml distilled water with vigorous stirring (24,000 rpm). Immediately thereafter, a mixture of 50 g tert-butanol and 50 g distilled water was added to the suspension formed and the mixture was then stirred vigorously (24,000 rpm) for 10 min. The solid was isolated by filtration and then stirred (10,000 rpm) with a mixture of 87.5 g tert-butanol and 37.5 g distilled water for 10 min. and filtered off again. This washing operation was repeated twice more. After the last filtration, the catalyst was dried to constant weight at 50° C. under normal pressure.

Yield of dried, pulverulent catalyst: 1.3 g

Elemental analysis: cobalt=25.4 wt. %, nickel=24.5 wt. %

### Example B

### DMC Catalyst Containing Co[Ni(CN)₄] and Tert-Butanol, and Polypropylene Glycol PPG 2000 as an Additional Complexing Component

A solution of 12.1 g (53.0 mmol) cobalt(II) sulfate heptahydrate in 17 ml distilled water was added to a solution of 2.5 g (10.4 mmol) potassium tetracyanonickelate in 61 ml distilled water with vigorous stirring (24,000 rpm). Immediately thereafter, a mixture of 43.5 g tert-butanol and 43.5 g distilled water was added to the suspension formed and the mixture was then stirred vigorously (24,000 rpm) for 10 min. A mixture of 0.9 g tert-butanol, 0.9 g PPG 2000 (DESMOPHEN 3600 Z, Bayer MaterialScience AG) and 87 g distilled water was then added and the mixture was stirred at 1,000 rpm for 3 min. The solid was isolated by filtration and then stirred (10,000 rpm) with a mixture of 60.9 g tert-butanol, 0.9 g PPG 2000 and 26.1 g distilled water for 10 min. and filtered off again. It was then stirred (10,000 rpm) once again with a mixture of 87 g tert-butanol and 0.4 g PPG 2000 for 10 min. and filtered off again. After the last filtration, the catalyst is dried under a high vacuum at 60° C. for 2 hours.

Yield of dried, pulverulent catalyst: 1.8 g

Elemental analysis: cobalt=25.5 wt. %, nickel=22.4 wt. %

### Example C

### DMC Catalyst Containing Co[Ni(CN)₄] and Tert-Butanol

A solution of 15.2 g (66.6 mmol) cobalt(II) sulfate heptahydrate in 16 ml distilled water was added to a solution of 2.4 g (10.0 mmol) potassium tetracyanonickelate in 60 ml distilled water and 8.4 g tert-butanol with vigorous stirring (24,000 rpm). Thereafter, the suspension formed was stirred vigorously (24,000 rpm) for 10 min. The solid was isolated by filtration and then stirred (10,000 rpm) with a mixture of 21.6 g tert-butanol and 10.8 g distilled water for 10 min. and filtered off again. It was then stirred (10,000 rpm) once again with 31.2 g tert-butanol for 10 min. and filtered off again. After the last filtration, the catalyst was dried under a high vacuum at 60° C. for 2 hours.

Yield of dried, pulverulent catalyst: 1.7 g

Elemental analysis: cobalt=25.9 wt. %, nickel=20.7 wt. %

### Example D

### DMC Catalyst Containing Co[Ni(CN)₄] and Tert-Butanol, and Polypropylene Glycol PPG 1000 as an Additional Complexing Component

A solution of 37.3 g (163.3 mmol) cobalt(II) sulfate heptahydrate in 74 g distilled water and 11 g tert-butanol was added to a solution of 2.4 g (10.0 mmol) potassium tetracyanonickelate in 25 ml distilled water with vigorous stirring (10,000 rpm). The suspension formed was then stirred vigorously (24,000 rpm) for 10 min. A mixture of 0.4 g tert-butanol, 2.1 g PPG 1000 (DESMOPHEN 1110 BD, Bayer MaterialScience AG) and 12.3 g distilled water was then added and the mixture was stirred at 10,000 rpm for 3 min. The solid was isolated by filtration and then stirred (10,000 rpm) with a mixture of 27.3 g tert-butanol, 0.5 g PPG 1000 and 14.2 g distilled water for 10 min. and filtered off again. It was then stirred (10,000 rpm) once again with a mixture of 39 g tert-butanol and 0.3 g PPG 1000 for 10 min. and filtered off again. After the last filtration, the catalyst was dried under a high vacuum at 60° C. for 2 hours.

Yield of dried, pulverulent catalyst: 2.0 g

Elemental analysis: cobalt=26.2 wt. %, nickel=17.9 wt. %

### Example E (Comparison)

DMC catalyst containing Co[Ni(CN)₄] without an organic complexing ligand (analogously to Robertson et al., in Dalton Trans., 2006, 5390-5395)

A solution of 6.5 g (23 mmol) cobalt(II) sulfate heptahydrate in 94 ml distilled water was added to a solution of 5.5 g (23 mmol) potassium tetracyanonickelate in 95 ml distilled water with vigorous stirring. Immediately thereafter, 100 g distilled water were added to the suspension formed and the mixture was then stirred vigorously (24,000 rpm) for 1 hour. The solid was isolated by filtration and the catalyst was then dried under a high vacuum at 60° C. for 10 hours.

Yield of dried, pulverulent catalyst: 2.0 g

### Preparation of Polyether Polyols

### General Procedure

50 g polypropylene glycol starter (number-average molecular weight=1,000 g/mol) and 200 mg catalyst were initially introduced into a 500 ml pressure reactor under an inert gas (nitrogen) and were heated up to 105° C., while stirring. Propylene oxide (approx. 10 g) was then metered in all at once, until the total pressure had risen to 3.5 bar. Further propylene oxide was then metered in again only when an accelerated drop in pressure was observed in the reactor. This accelerated drop in pressure indicates that the catalyst was activated. The remaining propylene oxide (140 g) was then metered in continuously under a constant total pressure of 2.5 bar. After all the propylene oxide had been metered in and after an after-reaction time of 1 hour at 105° C., volatile contents were distilled off at 90° C. (1 mbar) and the reaction mixture was then cooled to room temperature.

The polyether polyols obtained were characterized by determination of the OH numbers and the double bond contents.

The course of the reaction was monitored with the aid of time/conversion curves (propylene oxide consumption [g] v. reaction time [min]). The induction time was determined from the point of intersection of the tangent at the steepest point of the time/conversion curve with the extended base line of the curve. The propoxylation times decisive for the catalyst activity correspond to the period of time between activation of the catalyst (end of the induction period) and the end of the metering of propylene oxide. The total reaction time is the sum of the induction and propoxylation time.

### Example 1

### Preparation of Polyether Polyol with Catalyst A

| Induction time: | 0 min |
|---|---|
| Propoxylation time: | 46 min |
| Total reaction time: | 46 min |
| Polyether polyol: OH number (mg KOH/g): | 29.9 |
| Double bond content (mmol/kg): | 2 |

### Example 2

### Preparation of Polyether Polyol with Catalyst B

| Induction time: | 0 min |
|---|---|
| Propoxylation time: | 38 min |
| Total reaction time: | 38 min |
| Polyether polyol: OH number (mg KOH/g): | 29.4 |
| Double bond content (mmol/kg): | 0 |

### Example 3

### Preparation of Polyether Polyol with Catalyst C

| Induction time: | 0 min |
|---|---|
| Propoxylation time: | 41 min |
| Total reaction time: | 41 min |
| Polyether polyol: OH number (mg KOH/g): | 29.8 |
| Double bond content (mmol/kg): | 1 |

### Example 4

### Preparation of Polyether Polyol with Catalyst D

| Induction time: | 0 min |
|---|---|
| Propoxylation time: | 20 min |
| Total reaction time: | 20 min |
| Polyether polyol: OH number (mg KOH/g): | 29.8 |
| double bond content (mmol/kg): | 0 |

### Example 5 (Comparison)

### Preparation of Polyether Polyol with Catalyst E (Comparison)

| Induction time: | 31 min |
|---|---|
| Propoxylation time: | 360 min |
| Total reaction time: | 391 min |
| Polyether polyol: OH number (mg KOH/g): | 31.2 |
| Double bond content (mmol/kg): | 12 |

A comparison of Example 1-4 with Example 5 (comparison) shows that the DMC catalysts according to the invention no longer have an induction period in the preparation of polyether polyols. Furthermore, polyether polyols which have extremely low double bond contents are obtained by using these DMC catalysts.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A double metal cyanide (DMC) catalyst comprising:
a) one or more double metal cyanide compounds of the formula
M[M′(CN)₄]
wherein
M is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II), and
M′ is chosen from the metals Zn(II), Fe(II), Ni(II), Mn(II), Co(II), Sn(II), Pb(II), Sr(II), Cu(II), Cd(II), Hg(II), Pd(II), Pt(II), V(II), Mg(II), Ca(II) and Ba(II),
b) one or more organic complexing ligands selected from the group consisting of alcohols, aldehydes, ketones, ethers, esters, amides, ureas, nitriles and sulfides,
and optionally
c) one or more complexing component(s) which differ from b) and are selected from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose, polyacetals, glycidyl ethers, glycosides, carboxylic acid esters of polyhydric alcohols, bile acids or salts, esters or amides thereof, cyclodextrins, phosphorus compounds, α,β-unsaturated carboxylic acid esters and ionic surface- or interface-active compounds.

2. The DMC catalyst according to claim 1, additionally comprising d) water and/or e) a water-soluble metal salt.

3. The DMC catalyst according to claim 1, wherein the double metal cyanide compound is cobalt(II) tetracyanonickelate(II).

4. The DMC catalyst according to claim 1, wherein the organic complexing ligand is tert-butanol.

5. The DMC catalyst according to claim 1, wherein the catalyst comprises about 1 to about 80 wt. % of a polyether as complexing component c).

6. In a process for the preparation of polyether polyols by polyaddition of alkylene oxides on to starter compounds containing active hydrogen atoms, the improvement comprising conducting the process in the presence of one or more DMC catalysts according to claim 1.

7. A polyether polyol prepared by the process according to claim 6.

8. The polyether polyol prepared according to claim 6, wherein the double bond content is less than about 2 mmol/kg.

9. The polyether polyol according to claim 8 with a double bond content of less than about 1 mmol/kg.
